(19) United States
(12) Patent Application Publication
(10) Pub. No.: US 2013/0007004 A1
(43) Pub. Date: Jan. 3, 2013

(54) METHOD AND APPARATUS FOR CREATING A SEARCH INDEX FOR A COMPOSITE DOCUMENT AND SEARCHING SAME

(75) Inventors: Krishmin RAI, Chevy Chase, MD (US); George V. SHRECK, Springfield, VA (US)

(73) Assignee: Landon IP, Inc., Alexandria, VA (US)

(21) Appl. No.: 13/173,870

(22) Filed: Jun. 30, 2011

(51) Int. Cl. G06F 17/30; G06F 7/00

(52) U.S. Cl. 707/742; 707/741; 707/769; 707/E17.069; 707/E17.083; 707/E17.086

(57) ABSTRACT

A tool for generating at least one search index for a composite document, wherein the composite document comprises multiple component documents. The search index is generated by extracting characters from the document, segregating the characters into tokens of one or more characters, and determining location information of the tokens. The location information can include the page number of the component document and X, Y page coordinates for the tokens. The tool also provides a user interface that allows for searching of the composite document using at least one of the generated indexes. The user interface allows the user to enter one or more search terms and to select the criteria that will be used during the search. Results are presented to the user via a list of document names that are also hyperlinks to the document. The results documents are listed in order of relevancy, and fragments of text that contain the searched terms are also available to the user, for each document.

### BACKGROUND

The present invention relates generally to the process of searching electronic documents, and more specifically, to a system and method for creating a search index of composite documents and searching the index for desired documents.

Most legal transactions have a long and complicated history of documents, whether in digital form or hard copy. The group of documents can be considered a composite document. Each phase of the transaction is documented and, as negotiations between parties to the transaction progress, the legal terms change and are documented in the document history. As an example, a patent application is a transaction between the governing authority, such as the United States Patent and Trademark Office (USPTO) and the applicant for the patent. The applicant initiates the transaction, known as “patent prosecution”, by filing an application, which includes a “specification” describing the invention generally and “claims” which define the legal specification of the desired patent protection.

The applicant, often through an attorney, and a Patent Examiner, as a representative of the relevant patent office, engage in a series of document exchanges that will eventually form the “prosecution history” or “file history” of the patent application and/or the resulting patent. Specifically, the Examiner will issue documents called “Office Actions” indicating perceived inadequacies in the patent application, such as rejections of the claims and objections to the specification. The applicant can respond to each Office Action with documents containing arguments and/or amendments to the claims or specification. Accordingly, the legal specification of patent protection often changes significantly during prosecution. Also, the applicant often makes representations upon which the Examiner relies in granting or rejecting the patent application.

In order to accurately understand the legal specification, i.e. the legal metes and bounds of the invention protected by a patent, it is critical to review and understand the prosecution history of the patent. Typically, when a patent becomes part of a legal action, such as an action for infringement of the patent, attorneys will spend many hours reviewing, parsing, and analyzing the file history in order to understand the patent. Patent file histories are often many hundreds of pages. Further, the legal specification is changed throughout the prosecution process and through the effect of many documents in the file history. Accordingly, the process of reviewing the patent file history is tedious and requires a great deal of resources. Most significantly, it is difficult to locate specific portions of the file history that relate to specific words, phrases, or concepts.

Similarly, other transactions, such as merger or acquisition transactions, have long histories of documents that must be reviewed, parsed and analyzed in order to understand the legal specification of the transaction. Further, there are various legal and non-legal documents for which it is desirable to accurately search for terms, phrases, and concepts. It is, of course, known to record documents in digital form and to search the text electronically, using an index of the documents in order to find desired words or phrases. While this is an advance over a totally manual method of reading and parsing documents, conventional search methods still are limited in the ability to quickly locate specific relevant portions of complex composite documents that are composed of plural underlying documents.

Graphical User Interfaces (GUIs) are well known in the field of computers and computer applications. A GUI is designed to allow the information within the computer application to be displayed, usually in multiple ways, to the user. A typical user interface includes scroll bars that allow the user to scroll through a page or document that cannot be shown on the computer screen all at once. Typical user interfaces also provide links, or hyperlinks, to other places or objects on the page or document being viewed, and to other documents and webpages. A link can be presented as an object, such as a button to be clicked on. Links can also be presented, within a GUI, as a highlighted and/or underlined word or phrase. In both cases, clicking on the link causes a piece of code to be executed that causes the desired information to be fetched and presented to the user. GUI's for word processing applications also provide helpful functions, such as spell checker and the Find function, which allows the user to find the location of any word in the document. User interfaces may also present multiple windows within a display screen, so the user can view multiple documents simultaneously.

Documents and objects that can be linked to an existing electronic document, include word processing documents, Adobe® PDF files, webpages, image files, movie files, audio files, and other addressable objects. Exemplary word processing documents include .txt and .doc documents offered by Microsoft®, Inc. Link-able webpages are typically written in Hypertext Markup Language (HTML) and addressable via their Universal Resource Locator (URL), or Universal Resource Indicator (URI). Exemplary image files include JPEG, TIFF, GIFF and bit-map images. Link-able movie and audio files include .mov, Quicktime®, and WAV.

### SUMMARY

A method of creating a search index for one or more composite documents stored on a computer memory device to facilitate search of the document file. The method comprises extracting characters in the document file, segregating the characters into tokens of one or more characters, determining location information for at least some of the tokens, wherein the location information includes page coordinates indicating the location of a corresponding token within an underlying document of the document file. The method further comprises generating a search index including tokens and corresponding location information for the tokens, and storing the search index on a memory device in one or more files that are separate from the document file. The tokens can be words, and the step of segregating can include identifying spaces between characters.

The method includes querying the index of the document file. Querying the index comprises receiving a search query including at least one search term, querying the search index based on the search term(s), and returning search results including tokens from the search index that correspond to the search term and corresponding page location information indicating the location of each token within the underlying document. The page location information includes a link to the portion of the underlying document that includes the corresponding token. The step of receiving may further comprise querying the index using key words, and returning search results including the search terms that correspond to the key words. The method further comprises providing search results and links to the page coordinates of the document corresponding to location information from the index.

### BRIEF DESCRIPTION OF THE DRAWINGS

An embodiment will now be described in more detail with reference to the accompanying drawings, given only by way of example, in which:

FIG. 1 is a block diagram of an exemplary device on which the present embodiment may operate;

FIG. 2 is a schematic diagram showing the software modules of the embodiment;

FIG. 3 shows an exemplary network connection of the device;

FIG. 4 shows an exemplary document file that can be indexed and searched by the embodiment;

FIG. 5 shows an exemplary user interface that allows for search of one or more indexes;

FIG. 6 shows another exemplary user interface for reviewing results of a search;

FIG. 7 is a flow chart showing exemplary steps for creating an index;

FIG. 8 is a flow chart showing other exemplary for searching a document; and,

FIG. 9 shows an exemplary lookup table used by the embodiment to generate a search index.

### DETAILED DESCRIPTION OF THE INVENTION

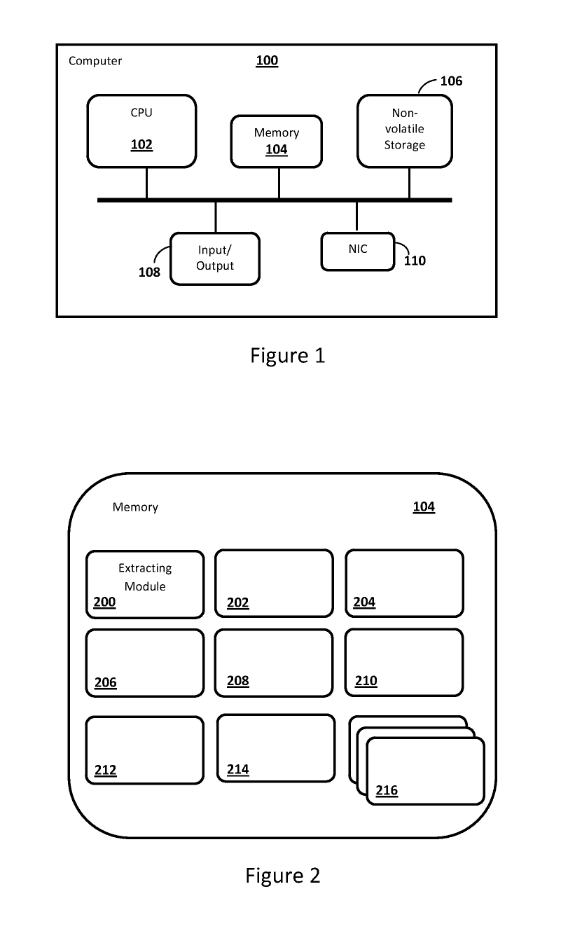

FIG. 1 shows an exemplary device, computer 100, on which the embodiment may operate. Computer 100 includes at least one Central Processing Unit (CPU) 102, a random access memory 104, a non-volatile storage device 106, a master input/output (I/O) unit 108, and a network interface card (NIC) 110. The computer can be any type of general purpose computing device, such as a PC, mobile device, or the like, or combination of one or more such devices. CPU 102 can be any well known, commercially available central processing unit, such as those offered by Intel®, Inc. The random access memory 104 serves as a workspace for executing software modules of the preferred embodiment. The non-volatile storage device 106 allows for storage of all data and instructions required for causing computer 100 to carry out the preferred method. The master I/O unit 108 accepts input from the user, via a keyboard and a pointing device, such as a computer mouse. The I/O unit 108 also outputs display screen information for viewing by the user. The network interface card 110 provides the computer 110 with access to a network, such as a Local Area Network (LAN) or the Internet.

FIG. 2 illustrates memory 104 storing software modules in the preferred embodiment. The modules comprise computer readable code recorded on a tangible media. Extracting Module 200 extracts characters from documents in a document file, or composite document, and puts the characters in reading order. Segregating Module 202 segregates the extracted characters into tokens, wherein a token can comprise a character, more than one character, and a word. Determining Module 204 determines the location of at least some of the tokens, wherein the location includes page coordinates indicating the location of each token within an underlying document of the document file, or composite document. Generating Module 206 takes the tokens and corresponding location information and generates a search index for the tokens. Storing Module 208 takes the search index generated by the Generating Module and stores the search index in a file that is separate from the document file. Receiving Module 210 accepts a search query from a user, wherein the search query includes at least one search term, or key word. Querying Module 212 queries a search index, based on the search term(s) from the Receiving Module, in order to find tokens matching the search term(s). Returning Module 214 takes the tokens found by the Querying Module, including the location information, and returns the search results to the user. The other software modules 216 provide other functionalities to the invention such as importing and exporting of the documents and reports. The disclosed modules are defined and segregated by function for convenience of description. However, the modules need not represent discrete files or sections of code recorded on media. The functions of the modules are described in greater detail below.

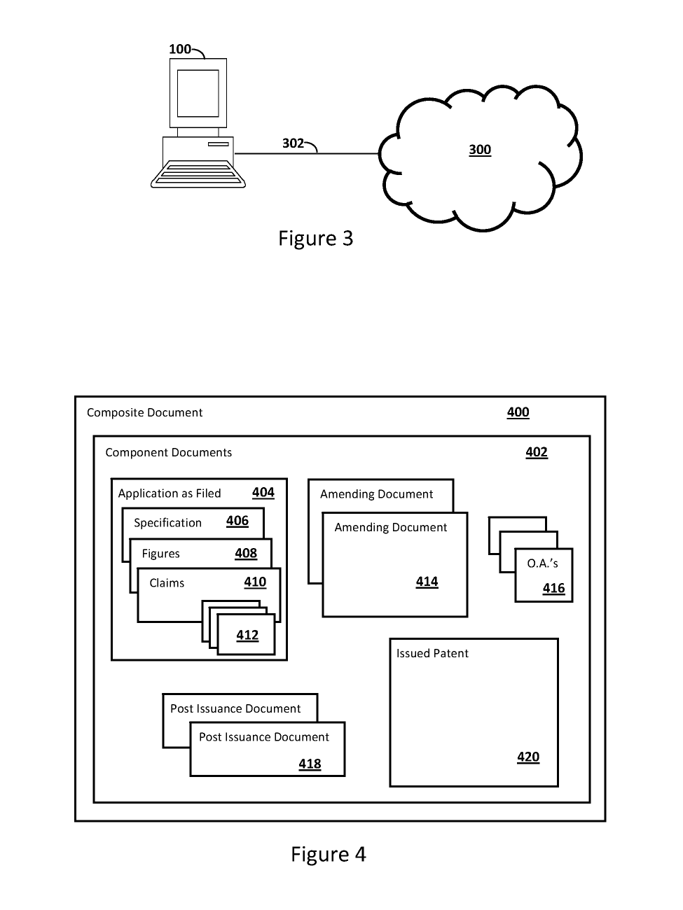

FIG. 3 shows the computer 100 connected to a network 300 via a connection 302. Connection 302 can be a wired or wireless connection and can use any media and protocols. The network 300 can be the Internet or a LAN that the computer 100 uses to connect to the Internet. Once connected to the Internet, the computer 100 is able to import publicly available electronic data, including information available on federal government servers such as those that support the U.S. Patent and Trademark Office, the Federal Trade Commission, various Courts, and the Securities and Exchange Commission.

FIG. 4 illustrates an exemplary Composite Document 400, or document file. The Composite Document 400 comprises multiple Component Documents 402. For composite documents such as the file history of a patent, exemplary component documents include an Application as Filed 404, Amending Documents 414, and the Issued Patent 420. The Application as Filed 404 includes a Specification 406, which describes the invention in writing, one or more FIGS. 408, which illustrate the invention, and one or more claims 410 that define the legal protection provided by a resulting patent. Other documents 412 in the Application include Information Disclosure Statements, wherein information material to patentability is submitted by the inventor. The Amending Documents 414 are submitted by the inventor, or the inventor's agent, often in response to Office Actions 416, which are issued by a patenting authority, such as the U.S. Patent Office. Post Issuance Documents 418 include all documents from the inventor, such as Reissue requests, and from the patenting authority, such as a Certificate of Correction.

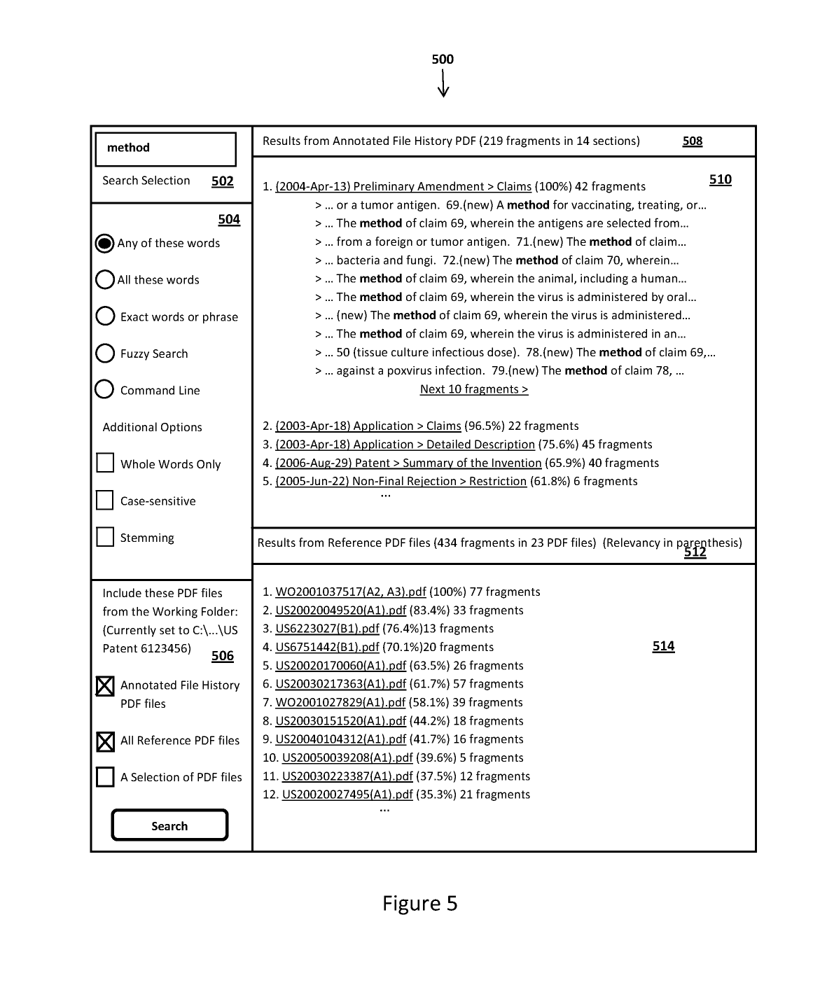

FIG. 5 shows an exemplary User Interface 500 for searching a composite document, or document file. Window 502 allows the user to enter one or more search terms, which will be used by the embodiment to find matching search terms. The search term can be one or more characters, an entire word, or more than one word. In this example, the word “method” has been entered as the search term, or key word. Window 504 allows the user to select the scope of matching to be used during the search. If more than one word is entered in window 502, the user can dictate that search results contain: any of the words; all of the words; the exact phrase; or, words that are close to the entered words. If the user selects Command Line, he is allowed to use Boolean expressions to better define his search. The lower portion of window 504 allows the user to select whether or not to limit the search to whole words only, or if stemming can be used during the search. The user is also allowed to dictate whether or not the search should be case sensitive. In window 506, the user is allowed to select which search indexes are to be used during the search. The embodiment allows for search indexes to be created for annotated file histories and non-annotated files. In this example, the user has selected to search annotated file histories and all non-annotated files. The user is also able to select a group of files for searching, if desired. After the user has entered his search term(s), selected the scope of the search and the indexes to be searched, he clicks on the “Search” button at the bottom of window 506.

Preliminary results from the search are shown in the right side of the interface 500. Window 508 provides a summary of results found in the search of the index of annotated file histories. In this example, 219 occurrences of the search term were found in 14 different sections of component documents. In the embodiment, occurrences of the search term are presented in fragments of the sentence in which the term is found. Window 510 lists the documents in which the search term was found in order of relevancy, with the most relevant document listed first. In the embodiment, names of the documents are links that when clicked display a list of fragments within the section of the document. The name of the section of the document is followed by an indication of the relevancy of the document, wherein the relevancy is displayed as a percentage. The relevancy percentage is followed by the number of fragments with the search term. In the embodiment, the first ten fragments of the first document containing the searched term are displayed in window 510 for the user to review. The searched terms are bolded in order to facilitate review by the user. If the user wishes to, he is given the option to display more fragments. The next most relevant documents are displayed under the fragments from the most relevant document.

Window 512 provides a summary of results found in the search of the index of non-annotated files. In this example, 434 fragments were found in 23 different PDF files. A list of the documents, or PDF files, is provided in window 514. Again, names of the documents are links that when clicked display a list of fragments within the actual document, and is followed by an indication of the relevancy of the document, shown as a percentage. The relevancy percentage is followed by the number of fragments within the document that contain the search term.

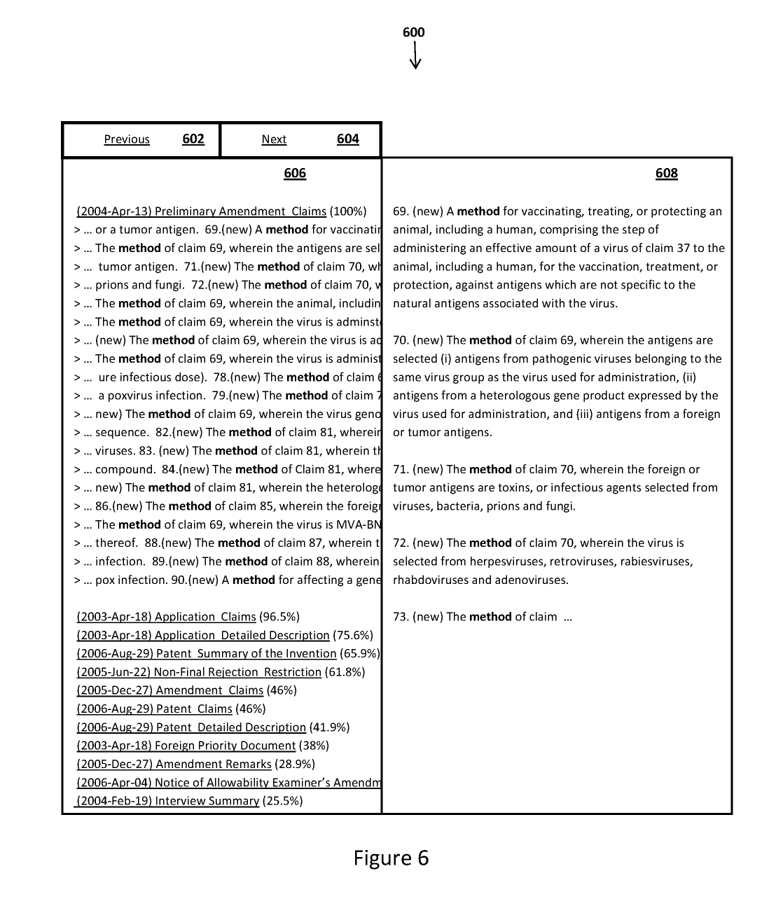

FIG. 6 shows another user interface 600 for the embodiment. User interface 600 shows more details of the search results. Window 606 is similar to window 510 in FIG. 5, it shows a listing of results of the search of the annotated file histories, in order of relevancy. In window 606, the most relevant document is listed first, and fragments found in the document are listed immediately after the document name. The next most relevant documents are listed below the fragments. Window 608 shows the full text of the fragments of the selected document. In this example, the selected document is a Preliminary Amendment, and more specifically, the claims section of the document. The full text of the claims are shown in window 608 and the user is able to scroll through the full text of the claims. In both windows 606 & 608 the searched terms are highlighted, bolded or otherwise made to stand out from the rest of the text. If the user wishes to see the fragments and full text of the next most relevant section, he clicks on the “Next” button in window 604. If the user wishes to return to a prior document, he can do so by clicking on the “Previous” button in window 602.

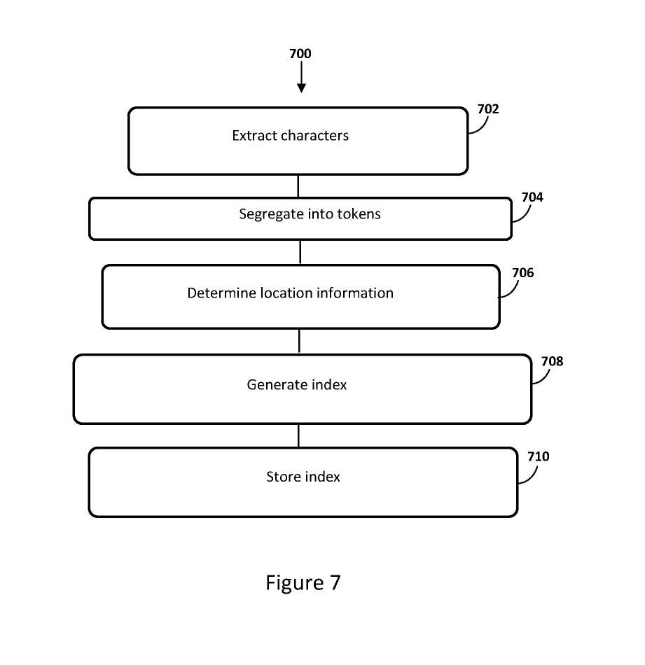

FIG. 7 is a flow chart showing exemplary steps in a method of the embodiment. In step 702, characters are extracted from a Document File, such as a file history. For an annotated file history, it is desirable to search different bookmarks, or sections, separately. In order to facilitate this, sections of the annotated file history are extracted separately. This is accomplished by determining all of the named destinations in the document, and assuming that all text after a specific destination and before the next destination, is part of that bookmark. For that determination, the visible top of the named destination can be compared with the Y coordinate of glyphs, or character image. Any glyph after that visible top, is part of the bookmark, and that section is extracted until we hit the next named destination. In the embodiment, TallComponents PDFControls 2.0 is used to retrieve a list of glyphs for each page in the PDF document. The glyphs can be natively sorted, or they can be sequenced generally relative to the partitions created by auto-zoning. Since the OCR process only indicates the location and size of each identified character, the method includes the ability to determine spaces between characters as extracted, which is done based on whitespace (dearth of other OCR characters). In step 704, the characters are segregated into tokens of one or more characters. During the segregation process, an analyzer is run that determines what to index and record. The characters, or text strings, are split into tokens and a list of documents that contain the tokens is recorded. The tokens can be created based on words, wherein every character is lowercased, and certain common words are ignored. A stemming analyzer, as well as other analyzers, may also be used to provide other indexes that provide advanced search features. In step 706, location information, including page coordinates, is determined for at least some of the tokens. In this example, tokens are created based on words. Also, during the analysis step the type of information remaining in the index can be controlled as desired. For example, stop words and grammatical variants like stems can be preserved or discarded.

For each character (including spaces identified with the process above), the page index and (x, y) coordinates with respect to the page may be recorded. These characters are stored in a minimal way and converted to base 64 in order to conserve space. The glyph and location string must accompany the full text of the document throughout the process to indicate where the fragments of PDF text came from. In step 708, a Search Index is generated for the Document File. The Search Index includes the tokens and corresponding location information for the tokens. In step 710, the Search Index is stored in a file that is separate from the Document File. Of course, these steps can be accomplished in various ways and in various order. For example, location information can be determined before character sequencing. In such a case, the location information can be processed after segregation to determine the location of the tokens.

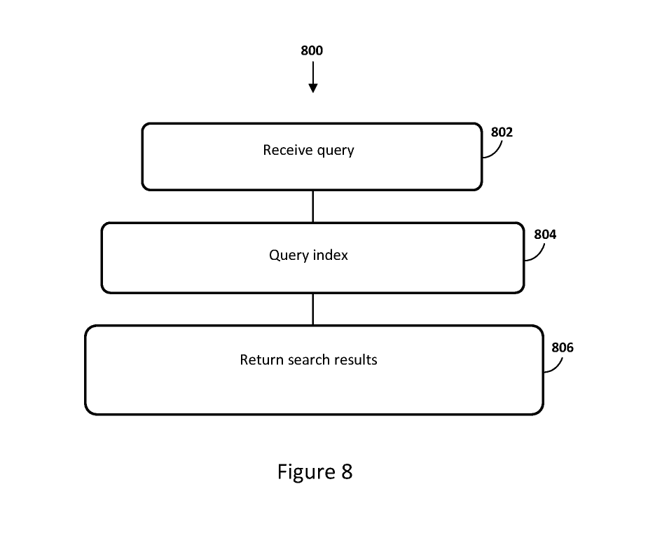

FIG. 8 is a flow chart showing exemplary steps in a search method of the embodiment. In step 802, a search query that includes at least one search term is received. The at least one search term can be received in a text entry window such as window 502 in FIG. 5. In step 804, the Search Index is queried, wherein the Search Index includes tokens and corresponding location information for the tokens. The queries are based on the user input and the selected search options. When more than one search term is used, a BooleanQuery is built comprising the multiple search terms, and using the requirements of whether or not all terms must occur. Known search engines, such as Apache Lucene can be used for the search engine. Lucene is an open source text search engine library written entirely in Java. Preferably, each individual term is also run through a query parser, which uses the associated index's analyzer to translate it accordingly. For example, if “the term” is searched, an index created with the StandardAnalyzer would never have a token of “the”, and the results would be no hits. If both terms (“the” and “term”) were forced through the analyzer, the results would be that “the” returns an empty query, and could be discarded. Long or complicated queries are rewritten. Rewriting unwraps more-complicated queries into constituent Boolean queries, and allows the embodiment to more easily determine what terms are being searched for. This is necessary to find the terms that need to be highlighted later. A filter can be created that allows the embodiment to only search for specific files. This option is helpful when the user chooses an explicit list of files to search against. In step 806, the results of the search are returned to the user. The results include tokens from the Search Index and corresponding page location information, also for the Search Index. More specifically, an object that contains a list of documents that match the specified search criteria is returned.

The list is natively sorted by document relevancy, which is a value determined based on internal scoring. Outside of the query, this value is not meaningful, so it is converted into a percentage before displaying it. A list of fragments that contain the search terms is also returned with each document, in order to provide the users with context and help them determine whether they want to follow the link to the entire document. The searched terms in the fragments, and in the full text, are bolded or highlighted for the benefit of the user. The character number of the first letter in each fragment is stored. The character number along with the glyph and location string allows the embodiment to retrieve the page and coordinates that correspond to the beginning of any particular fragment. This allows the embodiment to create hyperlinks that will jump to the spot in the document that corresponds to any fragment.

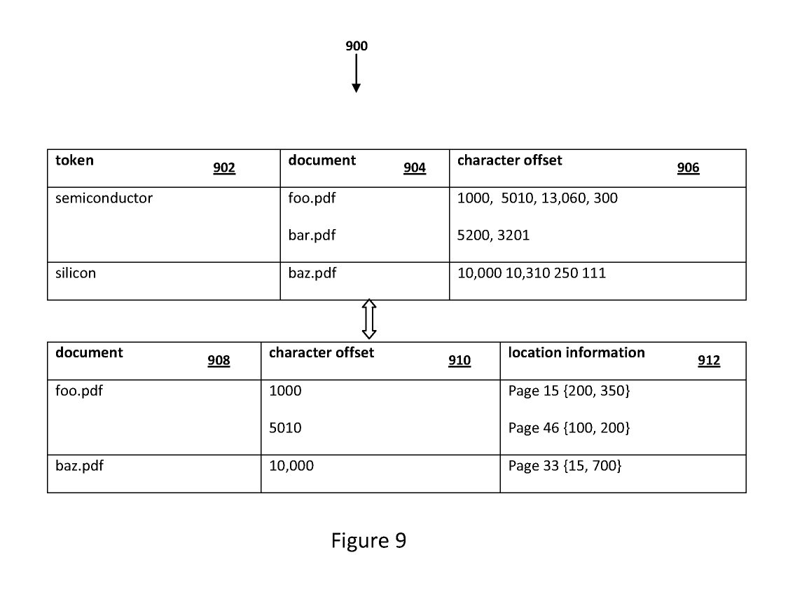

FIG. 9 is an exemplary data structure 900 of a search index. Column 902 of the table lists exemplary tokens that can be used as search terms. Column 904 lists the name of exemplary documents in which the tokens can be found. Column 906 provides the character offset for each occurrence of the token within each document. Column 908 lists the documents individually. Column 910 lists the character offsets for the token individually, with the corresponding location information listed in column 912. For example, the first occurrence of the token “semiconductor”, in the document named foo.pdf can be found on page 15 of the document, at (x, y) coordinates (200, 350). In another embodiment, the character offset for every character is stored in the lookup table.

The foregoing description of the embodiments will so fully reveal the general nature of the invention that others can, by applying current knowledge, readily modify and/or adapt for various applications such specific embodiments without departing from the generic concept. Therefore, such adaptations and modifications should and are intended to be comprehended within the meaning and range of equivalents of the invention. It is to be understood that the phraseology of terminology employed herein is for the purpose of description and not of limitation.

1. A method of creating a search index for a document file stored on a computer memory device to facilitate search of the document file, the method comprising:
extracting characters in the document file;
determining location information for at least some of the characters;
segregating the characters into tokens of one or more characters, the location information including page coordinates indicating a location of a corresponding token within an underlying document of the document file;
generating a search index including tokens and corresponding location information for the tokens; and
storing the search index on a memory device in a file that is separate from the document file.

2. The method of claim 1, wherein the tokens are words and wherein said segregating step comprises identifying spaces between characters.

3. A method of querying an index of a document file stored on a computer memory device to facilitate search of the document file, the method comprising:
receiving a search query including at least one search term;
querying a search index based on the search term, said search index including tokens and corresponding location information for the tokens, the tokens being defined by at least one character in the document file and the location information including page coordinates indicating a location of a corresponding token within an underlying document of the document file; and
returning search results including tokens from the search index that correspond to the search term and corresponding page location information indicating the location of each token within the underlying document.

4. The method of claim 3, wherein the page location information comprises a link to the portion of the underlying document that includes the corresponding token.

5. The method of claim 3, wherein said receiving step comprises:
querying an index using key words; and
returning search results including the search terms that correspond to the key words.

6. The method of claim 3, further comprising:
providing search results and links to the page coordinates of the document corresponding to location information from the index.

7. The method of claim 5, further comprising:
providing search results and links to the page coordinates of the document corresponding to location information from the index.

8. A computer system for creating a search index for a document file stored on a computer memory device to facilitate search of the document file, the system comprising:
at least one computer processor; and
a memory device operatively coupled to the at least one processor, said memory device storing computer executable instructions which, when executed by the at least one processor, cause the at least one processor to carry out the method comprising;
extracting characters in the document file,
determining location information for at least some of the characters,
segregating the characters into tokens of one or more characters, the location information including page coordinates indicating a location of a corresponding token within an underlying document of the document file,
generating a search index including tokens and corresponding location information for the tokens, and
storing the search index on a memory device in a file that is separate from the document file.

9. The system of claim 8, wherein the tokens are words and wherein said segregating step comprises identifying spaces between characters.

10. A computer system for querying an index of a document file stored on a computer memory to facilitate search of the document file, the system comprising:
at least one computer processor; and
a memory device operatively coupled to the at least one processor, said memory device storing computer executable instructions which, when executed by the at least one processor, cause the at least one processor to carry out the method comprising;
receiving a search query including at least one search term, querying a search index based on the search term, the index including tokens and corresponding location information, the tokens being defined by at least one character in the document file, and the location information including page coordinates indicating a location of a corresponding token within an underlying document of the document file, and
returning search results including tokens from the search index that correspond to the search term and corresponding page location information indicating the location of each token within the underlying document.

11. The system of claim 10, wherein the page location information comprises a link to the portion of the underlying document that includes the corresponding token.

12. The system of claim 10, wherein said receiving step comprises:
querying an index using key words; and
returning search results including the search terms that correspond to the key words.

13. The system of claim 10, the method further comprising:
providing search results and links to the page coordinates of the document corresponding to location information from the index.

14. The system of claim 12, the method further comprising:
providing search results and links to the page coordinates of the document corresponding to location information from the index.

15. Computer readable media for creating a search index for a document file stored on a computer memory device to facilitate search of the document file, the media having computer executable instructions stored thereon which, when executed by the at least one processor, cause the at least one processor to carry out the method comprising;
extracting characters in the document file,
determining location information for at least some of the characters,
segregating the characters into tokens of one or more characters, the location information including page coordinates indicating a location of a corresponding token within an underlying document of the document file,
generating a search index including tokens and corresponding location information for the tokens, and
storing the search index on a memory device in a file that is separate from the document file.

16. The media of claim 15, wherein the tokens are words and wherein said segregating step comprises identifying spaces between characters.

17. Computer readable media for querying an index of a document file stored on a computer memory to facilitate search of the document file, the media have computer executable instructions stored thereon which, when executed by the at least one processor, cause the at least one processor to carry out the method comprising;
receiving a search query including at least one search term,
querying a search index based on the search term, said search index including tokens and corresponding location information for the tokens, the tokens being defined by at least one character in the document file and the location information including page coordinates indicating a location of a corresponding token within an underlying document of the document file, and
returning search results including tokens from the search index that correspond to the search term and corresponding page location information indicating the location of each token within the underlying document.

18. The media of claim 17, wherein the page location information comprises a link to the portion of the underlying document that includes the corresponding token.

19. The media of claim 17, wherein said receiving step comprises:
querying an index using key words; and
returning search results including the search terms that correspond to the key words.

20. The media of claim 19, the method further comprising:
providing search results and links to the page coordinates of the document corresponding to location information from the index.

21. The media of claim 17, the method further comprising:
providing search results and links to the page coordinates of the document corresponding to location information from the index.

22. The method of claim 1, wherein the index comprises an inverted index and a lookup table, the inverted index including tokens, corresponding page indicators, and corresponding character offsets, the lookup table including character offsets and corresponding location information.

23. The method of claim 3, wherein the index comprises an inverted index and a lookup table, the inverted index including tokens, corresponding page indicators, and corresponding character offsets, the lookup table including character offsets and corresponding location information.

24. The system of claim 8, wherein the index comprises an inverted index and a lookup table, the inverted index including tokens, corresponding page indicators, and corresponding character offsets, the lookup table including character offsets and corresponding location information.

25. The system of claim 10, wherein the index comprises an inverted index and a lookup table, the inverted index including tokens, corresponding page indicators, and corresponding character offsets, the lookup table including character offsets and corresponding location information.

26. The media of claim 15, wherein the index comprises an inverted index and a lookup table, the inverted index including tokens, corresponding page indicators, and corresponding character offsets, the lookup table including character offsets and corresponding location information.

27. The media of claim 17, wherein the index comprises an inverted index and a lookup table, the inverted index including tokens, corresponding page indicators, and corresponding character offsets, the lookup table including character offsets and corresponding location information.

28. The method of claim 1, wherein the composite document comprises an image file including image information and text information corresponding to the image information.

29. The method of claim 3, wherein the composite document comprises an image file including image information and text information corresponding to the image information.

30. The system of claim 8, wherein the composite document comprises an image file including image information and text information corresponding to the image information.

31. The system of claim 10, wherein the composite document comprises an image file including image information and text information corresponding to the image information.

32. The media of claim 15, wherein the composite document comprises an image file including image information and text information corresponding to the image information.

33. The media of claim 17, wherein the composite document comprises an image file including image information and text information corresponding to the image information.
